(19) United States
(12) Patent Application Publication
(10) Pub. No.: US 2026/0006521 A1
(43) Pub. Date: Jan. 1, 2026

(54) ROAM HANDOFF BASED ON WIRELESS PERSONAL AREA NETWORK LINK

(71) Applicant: QUALCOMM Incorporated, San Diego, CA (US)

(72) Inventors: Hemant Kumar SAHOO, Hyderabad (IN); Shailendra Pratap SINGH, Hyderabad (IN); Mallikarjuna AKULA, Wanaparthy (IN); Sri Chaitanya CHALAMACHARLA, Hyderabad (IN)

(21) Appl. No.: 18/756,298

(22) Filed: Jun. 27, 2024

(51) Int. Cl. H04W 36/32; H04W 36/00; H04W 84/10

(52) U.S. Cl. CPC H04W 36/32; H04W 36/00835; H04W 84/10

(57) ABSTRACT

In some aspects, a wireless station may receive, over a wireless personal area network (WPAN) link, an indication of one or more roam triggers. The wireless station may transmit, over the WPAN link, an indication of a roam handoff candidate associated with the one or more roam triggers. Numerous other aspects are described.

### FIELD OF THE DISCLOSURE

Aspects of the present disclosure generally relate to wireless communication and, for example, to performing roam handoffs using wireless personal area network links.

### BACKGROUND

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a STA may move (or “roam”) from a first AP to a second AP. For example, the STA may roam from a first AP to a second AP in cases where the first AP is out of range and/or the second AP can provide higher data throughput and a more reliable connection than the first AP. Roaming may help to enable seamless data communication as STAa enter and exit the signal ranges of APs.

### SUMMARY

Some aspects described herein relate to a wireless station. The wireless station may include a processing system that includes processor circuitry and memory circuitry that stores code. The processing system may be configured to receive, over a wireless personal area network (WPAN) link, an indication of one or more roam triggers. The processing system may be configured to transmit, over the WPAN link, an indication of a roam handoff candidate associated with the one or more roam triggers.

Some aspects described herein relate to a wireless station. The wireless station may include a processing system that includes processor circuitry and memory circuitry that stores code. The processing system may be configured to transmit, over a WPAN link, an indication of one or more roam triggers. The processing system may be configured to receive, over the WPAN link, an indication of a roam handoff candidate associated with the one or more roam triggers.

Some aspects described herein relate to a method for wireless communication by a wireless station. The method may include receiving, over a WPAN link, an indication of one or more roam triggers. The method may include transmitting, over the WPAN link, an indication of a roam handoff candidate associated with the one or more roam triggers.

Some aspects described herein relate to a method of wireless communication by a wireless station. The method may include transmitting, over a WPAN link, an indication of one or more roam triggers. The method may include receiving, over the WPAN link, an indication of a roam handoff candidate associated with the one or more roam triggers.

Some aspects described herein relate to an apparatus for wireless communication. The apparatus may include means for receiving, over a WPAN link, an indication of one or more roam triggers. The apparatus may include means for transmitting, over the WPAN link, an indication of a roam handoff candidate associated with the one or more roam triggers.

Some aspects described herein relate to an apparatus for wireless communication. The apparatus may include means for transmitting, over a WPAN link, an indication of one or more roam triggers. The apparatus may include means for receiving, over the WPAN link, an indication of a roam handoff candidate associated with the one or more roam triggers.

Some aspects described herein relate to a non-transitory computer-readable medium that stores a set of instructions for wireless communication. The set of instructions may include one or more instructions that, when executed by one or more processors of a wireless station, cause the wireless station to receive, over a WPAN link, an indication of one or more roam triggers. The set of instructions may include one or more instructions that, when executed by one or more processors of the wireless station, may cause the wireless station to transmit, over the WPAN link, an indication of a roam handoff candidate associated with the one or more roam triggers.

Some aspects described herein relate to a non-transitory computer-readable medium that stores a set of instructions for wireless communication. The set of instructions may include one or more instructions that, when executed by one or more processors of a wireless station, may cause the wireless station to transmit, over a WPAN link, an indication of one or more roam triggers. The set of instructions may include one or more instructions that, when executed by one or more processors of the wireless station, may cause the wireless station to receive, over the WPAN link, an indication of a roam handoff candidate associated with the one or more roam triggers.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 shows a pictorial diagram of an example wireless communication environment.

FIG. 2 is a diagram illustrating example components of a device, in accordance with the present disclosure.

FIG. 3 is a diagram illustrating an example of roaming in a wireless local area network (WLAN), in accordance with the present disclosure.

FIG. 4 is a diagram illustrating an example of WLAN client roam triggering, in accordance with the present disclosure.

FIG. 5 is a diagram illustrating an example of roam handoffs for multiple STAs, in accordance with the present disclosure.

FIG. 6 is a diagram illustrating an example of signaling for roam handoffs for multiple wireless stations (STAs), in accordance with the present disclosure.

FIG. 7 is a diagram illustrating an example associated with signaling for a roam handoff based at least in part on a wireless personal area network (WPAN) link, in accordance with the present disclosure.

FIG. 8 is a diagram illustrating examples associated with roam handoffs based at least in part on a WPAN link, in accordance with the present disclosure.

FIG. 9 is a diagram illustrating an example associated with offloading a STA roam handover to a roamable access point, in accordance with the present disclosure.

FIG. 10 is a diagram illustrating another example associated with signaling for a roam handoff based at least in part on a WPAN link, in accordance with the present disclosure.

FIG. 11 is a flowchart of an example process associated with roam handoff based on a WPAN link, in accordance with the present disclosure.

FIG. 12 is a flowchart of an example process associated with roam handoff based on a WPAN link, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

A client (e.g., a Wi-Fi client) that is connected to one access point (AP) in an extended service set (ESS) may move, or “roam,” to another AP in the same ESS. Roaming (e.g., Wi-Fi roaming) may help to enhance seamless data communication for wireless devices (e.g., Wi-Fi devices) as the wireless devices move in and out of the signal range of various APs. Roaming should enable services to continue uninterrupted or seamlessly as the wireless devices move across a wireless network (e.g., a Wi-Fi network). Roaming may include at least three phases: a roaming trigger phase, during which a wireless device determines whether there is a need to roam; a candidate search and selection phase during which the wireless device identifies a best candidate to roam to; and a roaming handoff phase during which the wireless device roams to the best candidate.

In some examples, two wireless stations (e.g., wireless devices) may be connected using via a WPAN link, such as a Bluetooth link. Both wireless stations may be connected to the same AP. If the wireless stations move outside of a signal range of the AP, then both wireless stations may perform all three phases of WLAN client roam triggering to identify the best candidate for roaming. This process is redundant because both wireless stations are expected to determine that there is a need to roam at approximately the same time and/or are expected to identify the same best candidate. For example, during the second phase, each wireless station may perform a partial scan followed by a full scan until the wireless station identifies the best candidate. As a result, at least one of the wireless stations may use excessive power of at least one of the wireless stations. Additionally, or alternatively, both wireless stations may transmit probes during roam scanning, which can contribute to network congestion.

Various aspects relate generally to offloading at least a portion of a roam handoff procedure from one wireless station to another wireless station. Some aspects more specifically relate to exchanging information over a WPAN link connecting the wireless stations. In some examples, a first wireless station, such as an IoT device, may be connected to a second wireless station, such as a companion phone, over the WPAN link. The first wireless station may transmit, to a second wireless station, an indication of one or more roam triggers over the WPAN link. The roam trigger(s) may, when present, prompt the first wireless station to roam. The second wireless station may determine that there is a need for the first wireless station to roam based at least in part on the one or more roam triggers and identify the best candidate for the first wireless station to which to roam. For example, the second wireless station may perform the first and second phases of roaming on behalf of the first wireless station. The second wireless station may transmit, to the first wireless station, an indication of the best candidate over the WPAN link. The second wireless station may then perform the third phase of roaming (e.g., roaming to the best candidate).

Particular aspects of the subject matter described in this disclosure can be implemented to realize one or more of the following potential advantages. In some examples, by transmitting the indication of the best candidate to the first wireless station, the described techniques can be used to conserve power on the first wireless station by offloading at least the first and/or second phases to the second wireless station. Thus, the first wireless station may avoid using power for identifying the roam handoff candidate (e.g., the first wireless station may avoid performing unnecessary scans for the roam handoff candidate, initiating a roam trigger mechanism, roam handoff tracking, or the like). Additionally, or alternatively, the first wireless station may refrain from transmitting probes during roam scanning, thereby reducing network congestion.

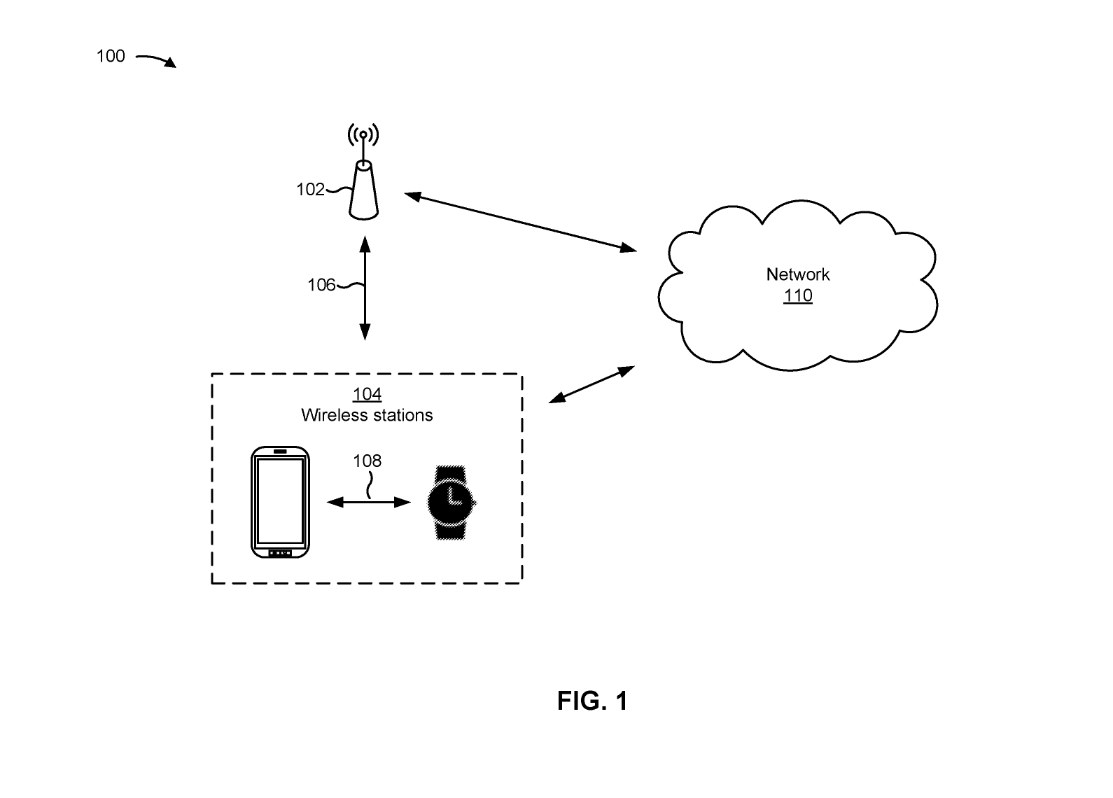

FIG. 1 shows a pictorial diagram of an example wireless communication environment 100.

The wireless communication environment 100 may include numerous wireless communication devices including at least one wireless AP 102 and any number of wireless stations (STAs) 104. While only one AP 102 is shown in FIG. 1, the wireless communication environment 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices, such as mobile phones (e.g., smart phones), other handheld or wearable communication devices (e.g., smart watches), netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication environment 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication environment 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network. In such examples, while the STAs 104 may be capable of communicating with each other through the AP 102 using communication links 106, STAs 104 also can communicate directly with each other via a WPAN link 108. Additionally, two STAs 104 may communicate via a WPAN link 108 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of the WPAN link 108 include a Bluetooth link, a Bluetooth low energy (BLE) link, or any other suitable P2P group connection.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication environment 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz – 7.125 GHz), FR2 (24.25 GHz – 52.6 GHz), FR3 (7.125 GHz – 24.25 GHz), FR4a or FR4-1 (52.6 GHz – 71 GHz), FR4 (52.6 GHz – 114.25 GHz), and FR5 (114.25 GHz – 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

According to some aspects, the wireless communication environment 100 may include a wireless communication network 110. The wireless communication network 110 can be an example of a WLAN such as a Wi-Fi network. For example, the wireless communication network 110 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 110 can be an example of a cellular RAN, such as a 5G or 6G RAN that implements one or more cellular protocols such as those specified in one or more 3GPP standards. In some other examples, the wireless communication network 110 can include a WLAN that functions in an interoperable or converged manner with one or more cellular RANs to provide greater or enhanced network coverage to wireless communication devices within the wireless communication network 110 or to enable such devices to connect to a cellular network’s core, such as to access the network management capabilities and functionality offered by the cellular network core. In some other examples, the wireless communication network 110 can include a WLAN that functions in an interoperable or converged manner with one or more personal area networks, such as a network implementing Bluetooth or other wireless technologies, to provide greater or enhanced network coverage or to provide or enable other capabilities, functionality, applications or services. In some examples, the wireless communication network 110 may include the APs 102 and/or the STAs 104.

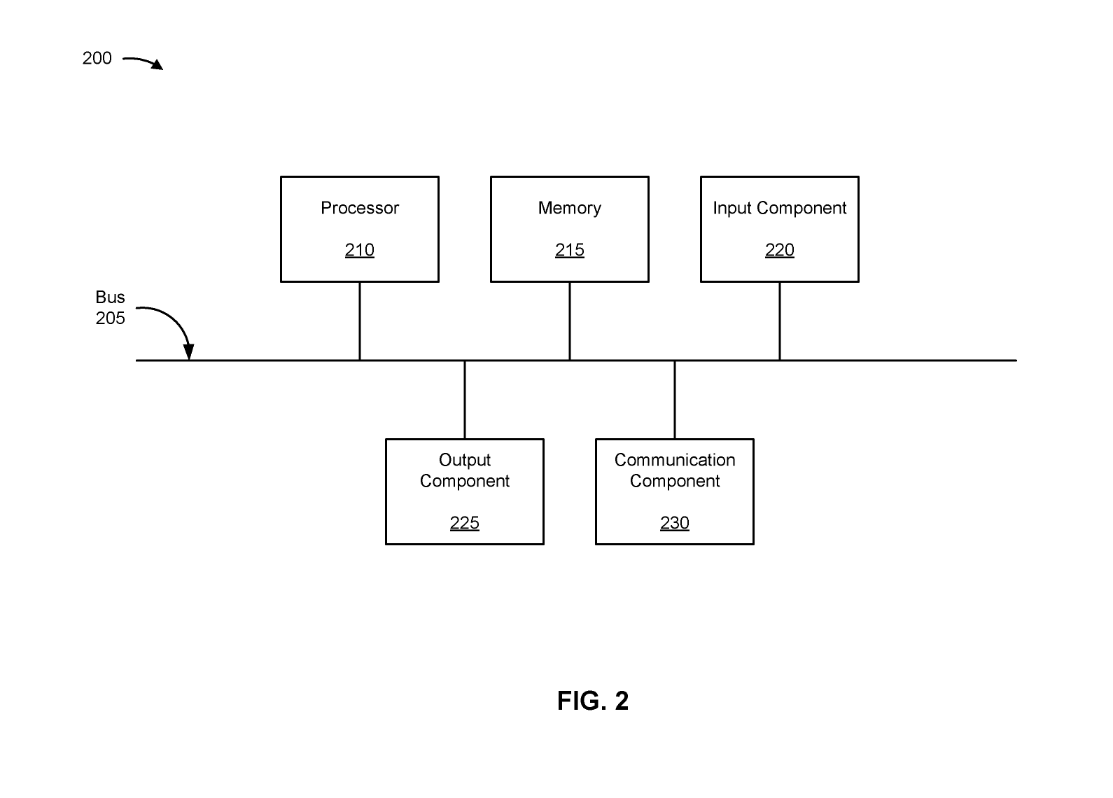

FIG. 2 is a diagram illustrating example components of a device 200, in accordance with the present disclosure. The device 200 may correspond to a STA 104. In some aspects, the STA 104 may include one or more devices 200 and/or one or more components of the device 200. As shown in FIG. 2, the device 200 may include a bus 205, a processor 210, a memory 215, an input component 220, an output component 225, and/or a communication component 230.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for receiving, over a WPAN link, an indication of one or more roam triggers; and/or means for transmitting, over the WPAN link, an indication of a roam handoff candidate associated with the one or more roam triggers. In some aspects, device 200 may include means for transmitting, over a WPAN link, an indication of one or more roam triggers; and/or means for receiving, over the WPAN link, an indication of a roam handoff candidate associated with the one or more roam triggers. In some aspects, the means for device 200 to perform processes and/or operations described herein may include one or more components of device 200 described in connection with FIG. 2, such as bus 205, processor 210, memory 215, input component 220, output component 225, and/or communication component 230.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

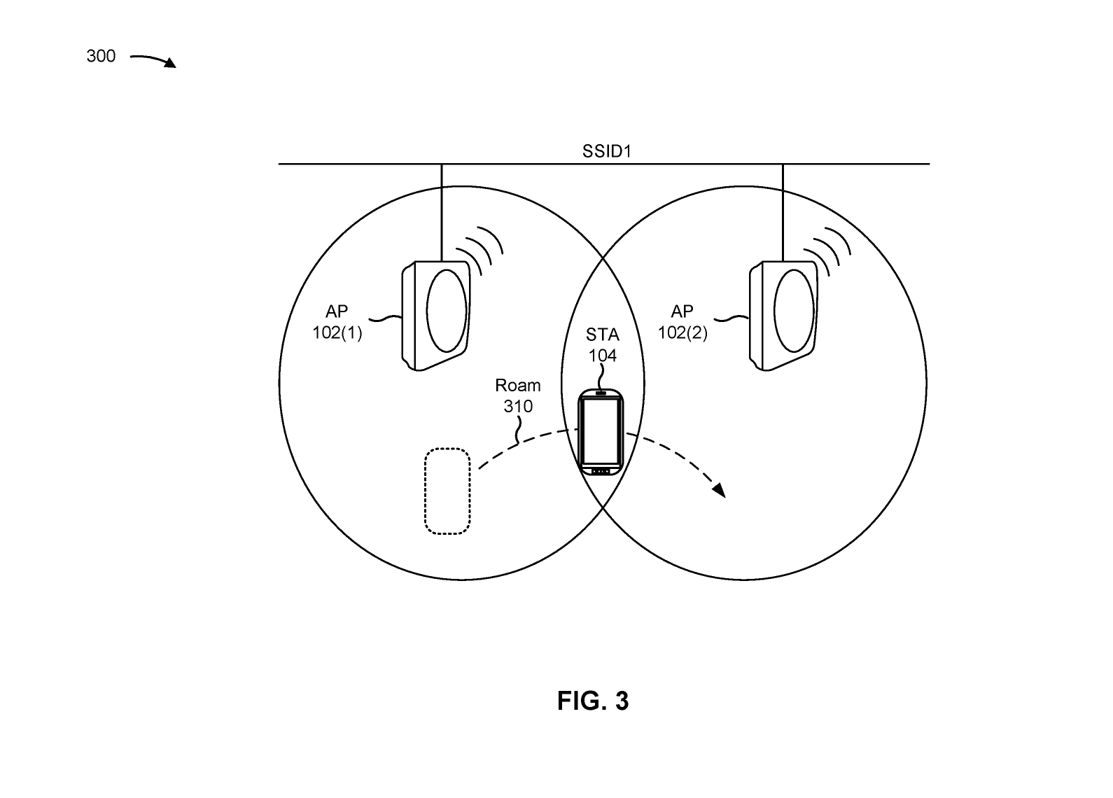

FIG. 3 is a diagram illustrating an example 300 of roaming in a WLAN, in accordance with the present disclosure.

Example 300 includes an AP 102(1), an AP 102(2), and a STA 104 (e.g., a Wi-Fi client) connected to AP 102(1). APs 102(1) and 102(2) belong to the same ESS corresponding to an SSID (“SSID1”). As shown by reference number 310, the STA 104 may move, or “roam,” from AP 102(1) to AP 102(2). Roaming may enable the STA 104 to identify and connect to the AP 102(2), which may have higher data throughput and a more reliable connection than the AP 102(1), which may have an out-of-range signal with respect to the STA 104.

As indicated above, FIG. 3 is provided as an example. Other examples may differ from what is described with respect to FIG. 3.

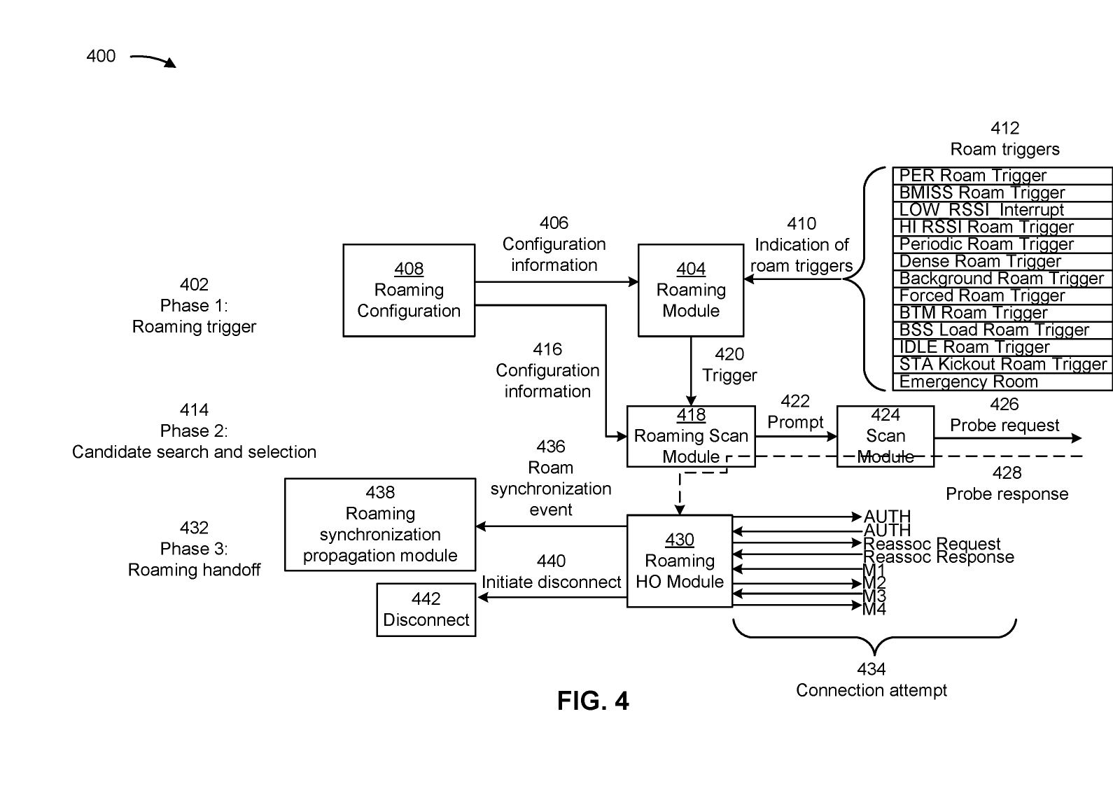

FIG. 4 is a diagram illustrating an example 400 of WLAN client roam triggering, in accordance with the present disclosure. In at least Wi-Fi, roaming may be split into three distinct phases, each having a specific purpose and clearly defined inputs and actions. The STA 104 may follow each phase to roam from AP 102(1) to AP 102(2).

A first phase 402 (“Phase 1”) is a roaming trigger phase during which the STA 104 determines whether there is a need to roam. As shown by reference number 406, a roaming module 404 may receive configuration information from a roaming configuration 408. The configuration information may include an RSSI threshold, a beacon miss count, or the like. As shown by reference number 410, the roaming module 404 may also receive an indication of one or more roam triggers 412.

A second phase 414 (“Phase 2”) is a candidate search and selection phase during which the STA 104 determines to which AP to roam. As shown by reference number 416, a roaming scan module 418 may receive configuration information from the roaming configuration 408. The configuration information may include roaming channels, dwell times, AP profiles, or the like. As shown by reference number 420, the roaming scan module 418 may receive, from the roaming module 404, an indication that at least one of the roam triggers 412 has occurred in accordance with the roaming configuration 408. As shown by reference number 422, the roaming scan module 418 may prompt a scan module 424 to perform a candidate search. As shown by reference number 426, the scan module 424 may perform the candidate search by transmitting one or more probe requests. As shown by reference number 428, the scan module 424 may receive (e.g., from the AP 102(2) and/or other APs) a beacon and/or probe response and indicate the beacon and/or probe response to the roaming scan module 418; the roaming scan module 418 may, using candidate selection logic, select an AP (e.g., the AP 102(2)); and the roaming scan module 418 may indicate the selection to a roaming handoff module 430.

The third phase 432 (“Phase 3”) is a roaming handoff phase during which the STA 104 roams to the selected AP (e.g., the AP 102(2)). As shown by reference number 434, the roaming handoff module 430 may attempt to connect to the selected AP (e.g., by performing a virtual device management and/or key install procedure). As shown by reference number 436, the roaming handoff module 430 may provide an indication of a roam synchronization event to a roaming synchronization propagation module 438. The indication may include information relating to the selected AP, such as an authorization status, a BSSID, a roam reason, an RSSI, a beacon and/or probe response, a reassociation response frame, a channel, key material, or the like. As shown by reference number 440, the roaming handoff module 430 may initiate a disconnect 442 due to a roam event (e.g., a roam handoff failure).

As indicated above, FIG. 4 is provided as an example. Other examples may differ from what is described with respect to FIG. 4.

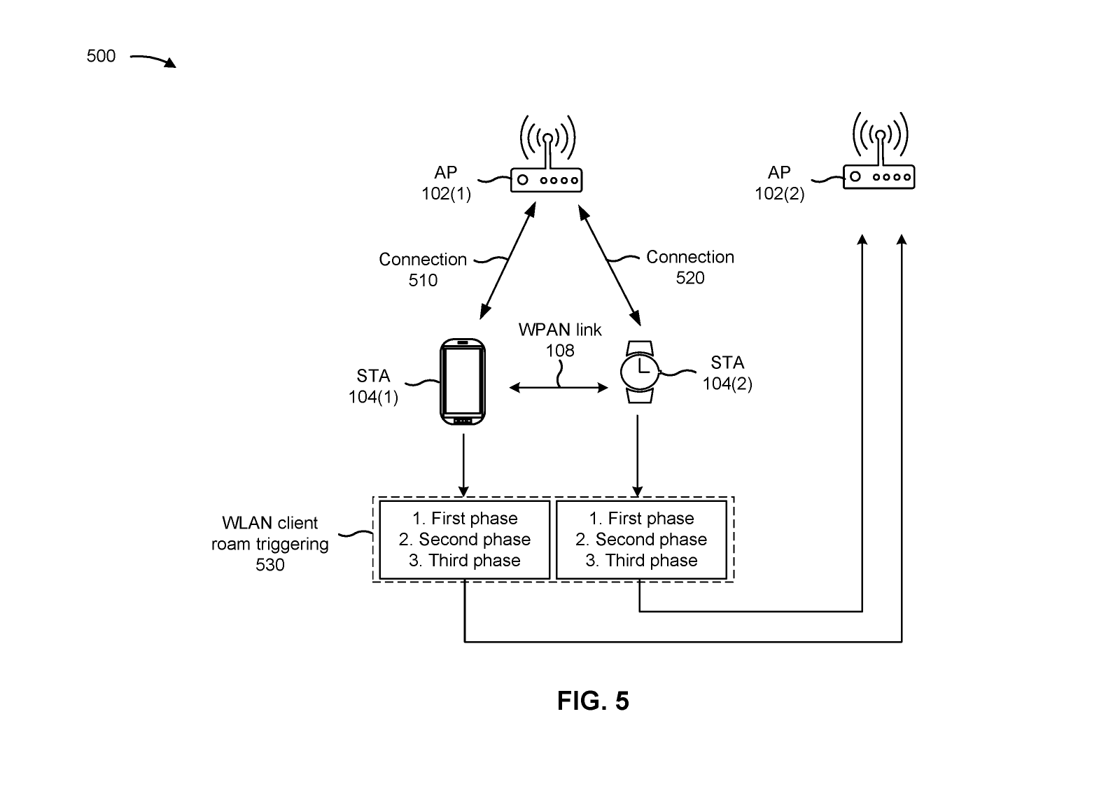

FIG. 5 is a diagram illustrating an example 500 of roam handoffs for multiple STAs, in accordance with the present disclosure.

As shown, a STA 104(1) (e.g., a smartphone) and a STA 104(2) (e.g., a smart watch) may be connected using the WPAN link 108. For example, the STA 104(1) may be a companion device (e.g., a companion phone) of the STA 104(2). As shown by reference number 510, the STA 104(1) may be connected to an AP 102(1). As shown by reference number 520, the STA 104(2) may be connected to the AP 102(1).

In some examples, the STA 104(1) and the STA 104(2) may roam from the AP 102(1) to an AP 102(2). As shown by reference number 530, the STA 104(1) and the STA 104(2) may each separately perform WLAN client roam triggering as described above in connection with FIG. 4. For example, both the STA 104(1) and the STA 104(2) may perform the first, second, and third phases of WLAN client roam triggering. For example, both STAs 104(1) and 104(2) may independently identify a better candidate than AP 102(1), such as AP 102(2), in response to a signal of the AP 102(1) being out of range.

As indicated above, FIG. 5 is provided as an example. Other examples may differ from what is described with respect to FIG. 5.

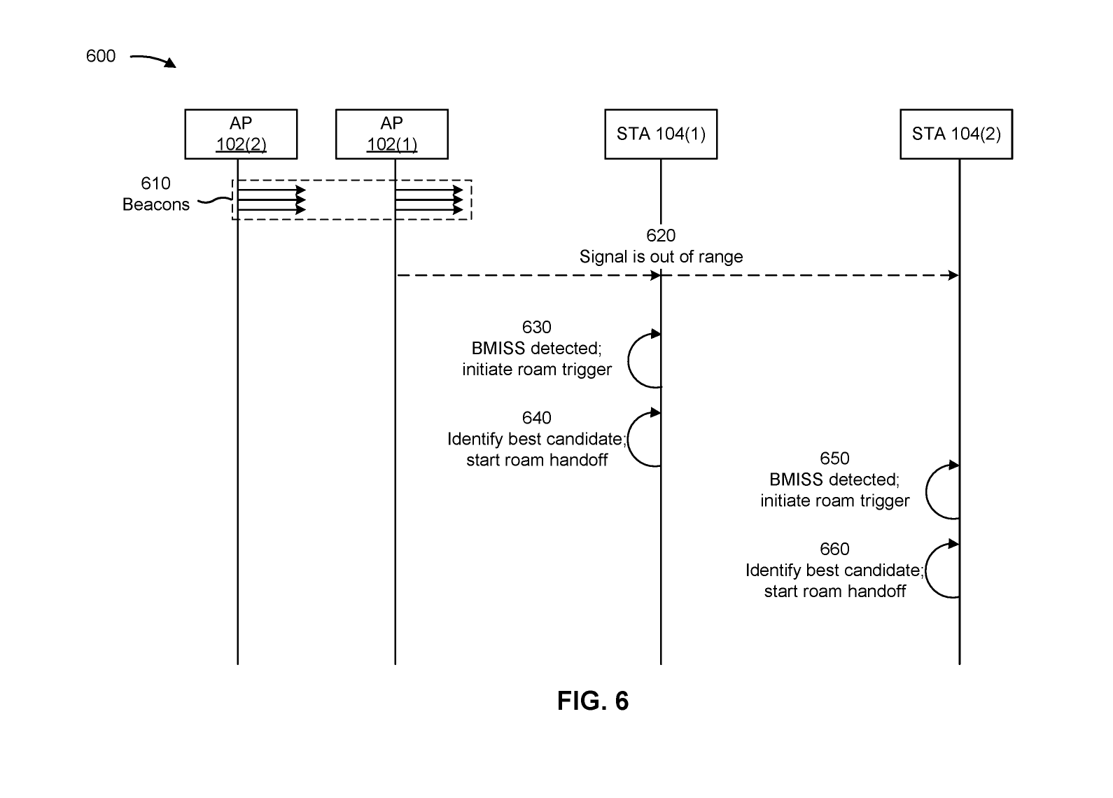

FIG. 6 is a diagram illustrating an example 600 of signaling for roam handoffs for multiple STAs, in accordance with the present disclosure.

As shown by reference number 610, APs 102(1) and 102(2) may transmit beacons at regular intervals. As shown by reference number 620, the STAs 104(1) and 104(2) may determine, based at least in part on the beacons transmitted by the AP 102(2), that the AP 102(1) is out of signal range.

As shown by reference number 630, the STA 104(1) may detect a beacon miss (“BMISS”) and initiate a roam trigger. As shown by reference number 640, the STA 104(1) may identify the AP 102(2) as the best candidate and start roam handoff. For example, the STA 104(1) may perform the first, second, and third phases of WLAN client roam triggering, as discussed above in connection with FIG. 5.

As shown by reference number 650, the STA 104(2) may detect a beacon miss and initiate a roam trigger. As shown by reference number 660, the STA 104(2) may identify the AP 102(2) as the best candidate and start roam handoff. For example, the STA 104(2) may perform the first, second, and third phases of WLAN client roam triggering, as discussed above in connection with FIG. 5.

Thus, both STAs 104(1) and 104(2) perform all three phases of WLAN client roam triggering to identify the best candidate for roaming. However, the STA 104(2) performing the first and second phases of WLAN client roam triggering is redundant because STA 104(1) also performs the first and second phases of WLAN client roam triggering. For example, the STA 104(1) already checks all conditions associated with selecting the best candidate; the STA 104(2) also checking all conditions associated with selecting the best candidate uses excessive power of the STA 104(2). For example, the STA 104(2) may perform a partial scan followed by a full scan until the STA 104(2) identifies the best candidate, which can require power. For example, the STA 104(2) may use approximately 0.75 mA (corresponding to approximately 980 ms) to scan all 2G channels. Additionally, or alternatively, the STA 104(2) transmits probes in WLAN channels during roam scanning, which contributes to network congestion.

As indicated above, FIG. 6 is provided as an example. Other examples may differ from what is described with respect to FIG. 6.

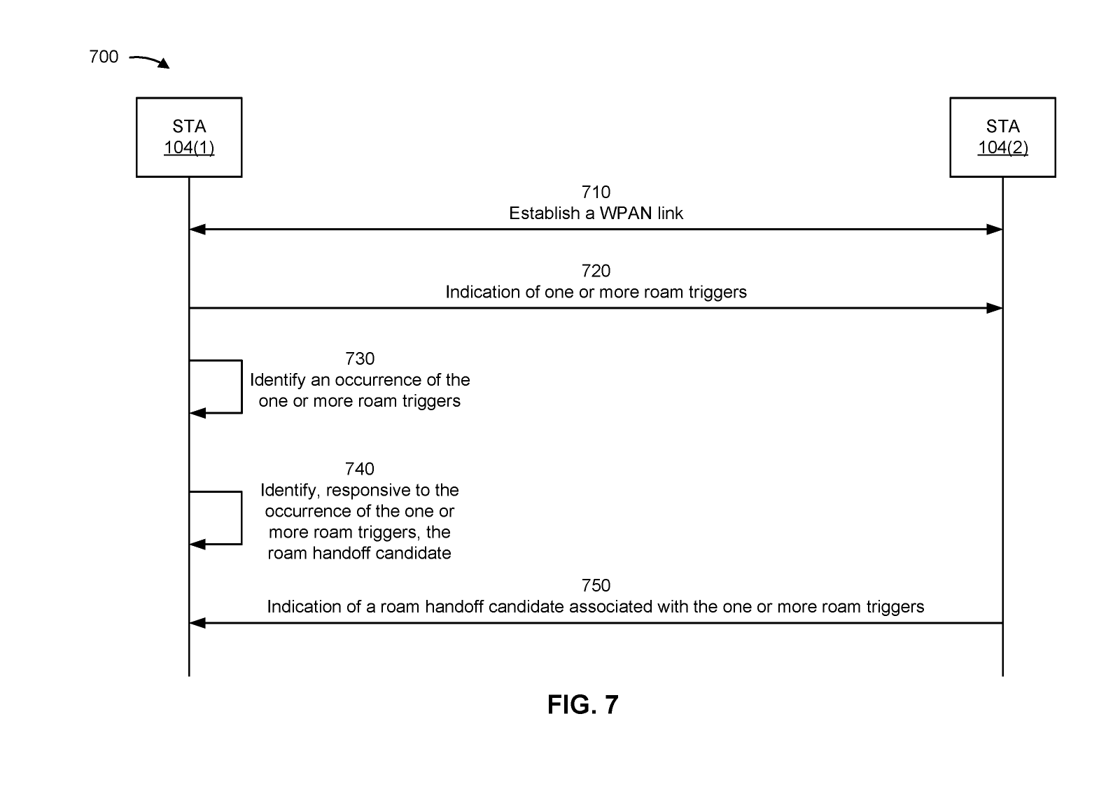

FIG. 7 is a diagram illustrating an example 700 associated with signaling for a roam handoff based at least in part on a WPAN link, in accordance with the present disclosure.

In some aspects, a STA 104(1) and a STA 104(2) may be associated with one another. For example, the STA 104(1) and the STA 104(2) may be associated with one another in that the STA 104(1) and the STA 104(2) may communicate with one another (e.g., over the WPAN link 108). In some examples, the STA 104(1) may be a companion device. For example, the STA 104(1) may be a companion device of the STA 104(2) in that the STA 104(1) may communicate with the STA 104(2) over the WPAN link 108. The STA 104(1) and the STA 104(2) may be any suitable type of STA 104, example of which are provided above (e.g., smart phones, IoT devices, or the like). In some examples, the STA 104(1) may be a smart phone. The STA 104(1) may also be referred to as a target device. The STA 104(2) may be any suitable roamable device with a companion device (e.g., the STA 104(1)) connected thereto. In some examples, the STA 104(2) may be an IoT device, such as a smartwatch, an XR device, a ring, a health device, an implanted device, an industrial IoT device that supports WLAN capabilities, or the like.

In some aspects, the STA 104(1) and/or the STA 104(2) may be connected to an AP (e.g., the AP 102(1)) associated with an ESS. For example, the AP 102(1) may be associated with the ESS in that the AP 102(1) belongs to, or is connected to, the ESS.

As shown by reference number 710, the STA 104(1) and the STA 104(2) may establish the WPAN link 108. As shown by reference number 720, the STA 104(2) may transmit, and the STA 104(1) may receive, over the WPAN link 108, an indication of one or more roam triggers. For example, the STA 104(2) may register a roam handoff with the STA 104(1). The one or more roam triggers may be the same as, or different from, one or more roam triggers of the STA 104(1).

In some aspects, the one or more roam triggers may include a beacon miss (“BMISS”) roam trigger. A beacon miss roam trigger may comprise a quantity of a set of missed beacons (e.g., consecutive beacons) satisfying (e.g., exceeding) a beacon miss threshold. Additionally, or alternatively, the one or more roam triggers may include any other suitable roam trigger, such as any suitable roam trigger shown in FIG. 4.

In some aspects, the STA 104(2) may transmit, and the STA 104(1) may receive, the indication of the one or more roam triggers responsive to establishing the WPAN link. For example, the STA 104(2) may register the roam handoff with the STA 104(1) when, or shortly after, the STA 104(1) and the STA 104(2) connect with each other (e.g., regardless of when the STA 104(1) and/or the STA 104(2) connect to, or perform roaming operations associated with, any APs).

In some aspects, the indication of the one or more roam triggers may comprise an indication to identify an occurrence of the one or more roam triggers and identify, responsive to the occurrence of the one or more roam triggers, the roam handoff candidate. As shown by reference number 730, the STA 104(1) may identify an occurrence of the one or more roam triggers. For example, the STA 104(1) may perform the first phase of WLAN client roam triggering (e.g., roam trigger), as discussed above in connection with FIG. 4. For example, the STA 104(1) may determine that the AP 102(1) is out of signal range and initiate roam triggering.

As shown by reference number 740, the STA 104(1) may identify, responsive to the occurrence of the one or more roam triggers, a roam handoff candidate associated with the one or more roam triggers. For example, the STA 104(1) may perform the second phase of WLAN client roam triggering, as discussed above in connection with FIG. 4 (e.g., candidate search and selection). The roam handoff candidate may be associated with the one or more roam triggers in that the STA 104(1) may identify the roam handoff candidate based at least in part on the one or more roam triggers (e.g., responsive to the occurrence of the one or more roam triggers).

In some aspects, the roam handoff candidate may be an AP (e.g., the AP 102(2)) associated with the ESS (e.g., the same ESS with which the AP 102(1) is associated). For example, the STA 104(1) may identify AP 102(2) as the best candidate for seamless roaming. The AP 102(2) may be associated with the ESS in that the AP 102(2) belongs to, or is connected to, the ESS. Thus, both APs 102(1) and 102(2) may be associated with the same ESS.

As shown by reference number 750, the STA 104(1) may transmit (e.g., share or auto-share), and the STA 104(2) may receive, over the WPAN link 108, an indication of the roam handoff candidate (e.g., AP 102(2)). In some examples, the indication of the roam handoff candidate may comprise roamable candidate information, such as credentials (e.g., roam handoff credentials) for roaming to the AP 102(2). The STA 104(1) may include logic for sharing the credentials with the STA 104(2) for seamless roaming. In some examples, the STA 104(2) may interpret (e.g., process) the roam handoff candidate and credentials for seamless roaming to the AP 102(2).

In some aspects, the indication of the roam handoff candidate may comprise an indication to perform a roam handoff associated with the roam handoff candidate. The roam handoff may be associated with the roam handoff candidate in that the STA 104(2) may perform (and/or attempt to perform) the roam handoff to the roam handoff candidate. In some examples, the STA 104(2) may perform the roam handoff responsive to receiving the indication of the roam handoff candidate.

As indicated above, FIG. 7 is provided as an example. Other examples may differ from what is described with respect to FIG. 7.

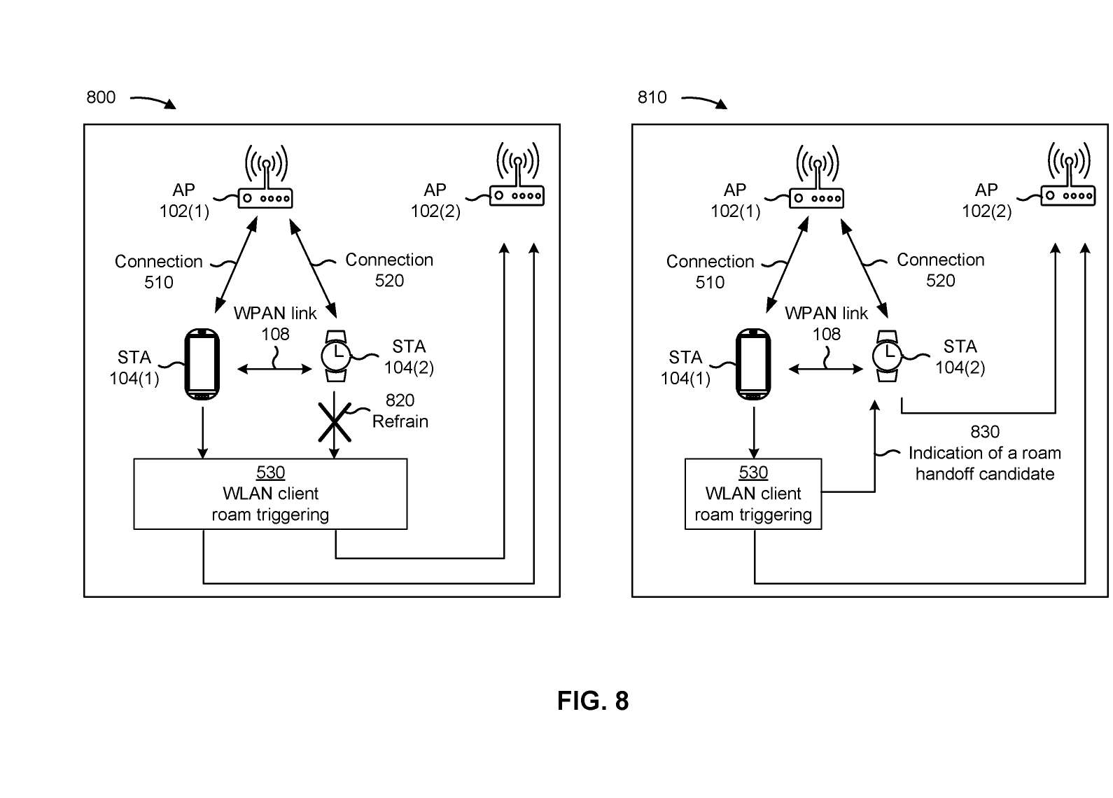

FIG. 8 is a diagram illustrating examples 800 and 810 associated with roam handoffs based at least in part on a WPAN link, in accordance with the present disclosure.

In example 800, as shown by reference number 530 and as described above in connection with FIG. 5, the STA 104(1) may perform WLAN client roam triggering. However, as shown by reference number 820, the STA 104(2) may refrain from performing the WLAN client roam triggering. In example 810, as shown by reference number 830 and as described above in connection with FIG. 7, the STA 104(1) may transmit, and the STA 104(2) may receive, an indication of a roam handoff candidate (e.g., the AP 102(2)).

As indicated above, FIG. 8 is provided as an example. Other examples may differ from what is described with respect to FIG. 8.

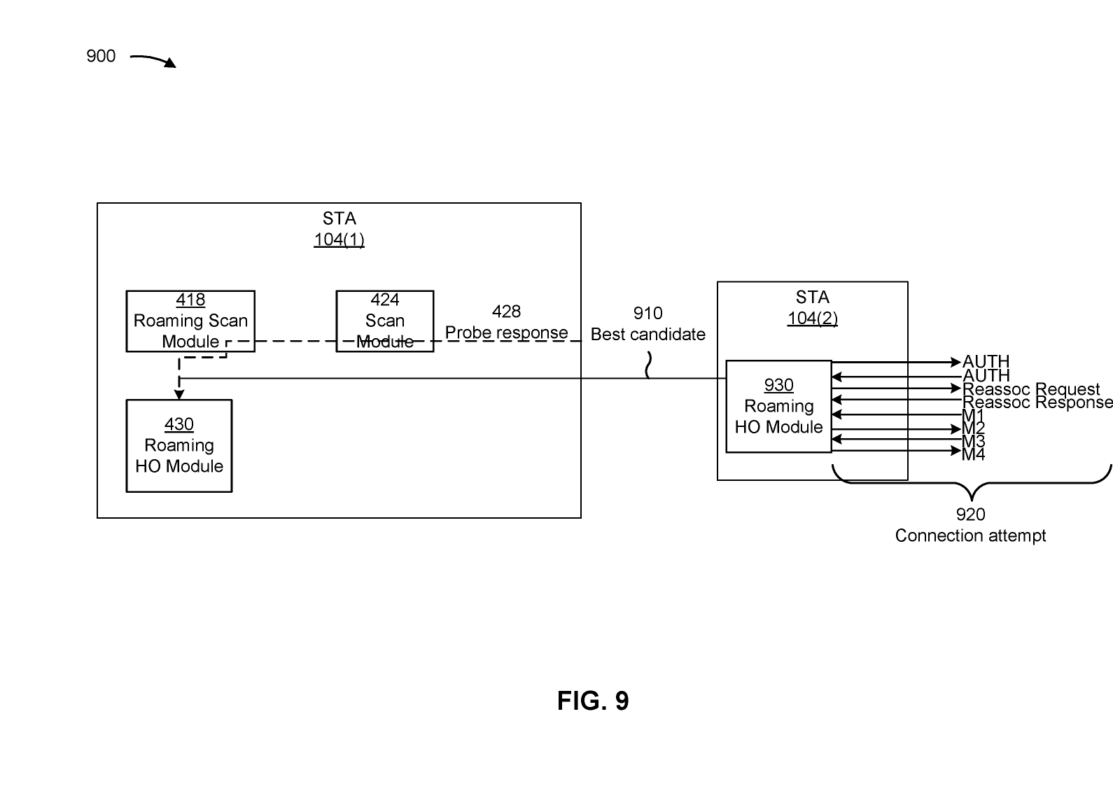

FIG. 9 is a diagram illustrating an example 900 associated with offloading a STA roam handover to a roamable AP, in accordance with the present disclosure.

As shown by reference number 910, during WLAN client roam triggering (e.g., as discusses above in connection with FIG. 4), the STA 104(1) may transmit (e.g., share) an indication of an indication of a roam handoff candidate (e.g., the best candidate) over the WPAN link 108. The best candidate may be the AP selected by the STA 104(1) (e.g., the AP 102(2)). As shown by reference number 920, a roaming handoff module 930 of the STA 104(2) may attempt to connect to the best candidate (e.g., by performing a virtual device management and/or key install procedure). For example, after receiving the indication of the best candidate, the STA 104(2) may connect to the best candidate without performing a candidate search (e.g., a roam scan) and/or candidate selection.

As indicated above, FIG. 9 is provided as an example. Other examples may differ from what is described with respect to FIG. 9.

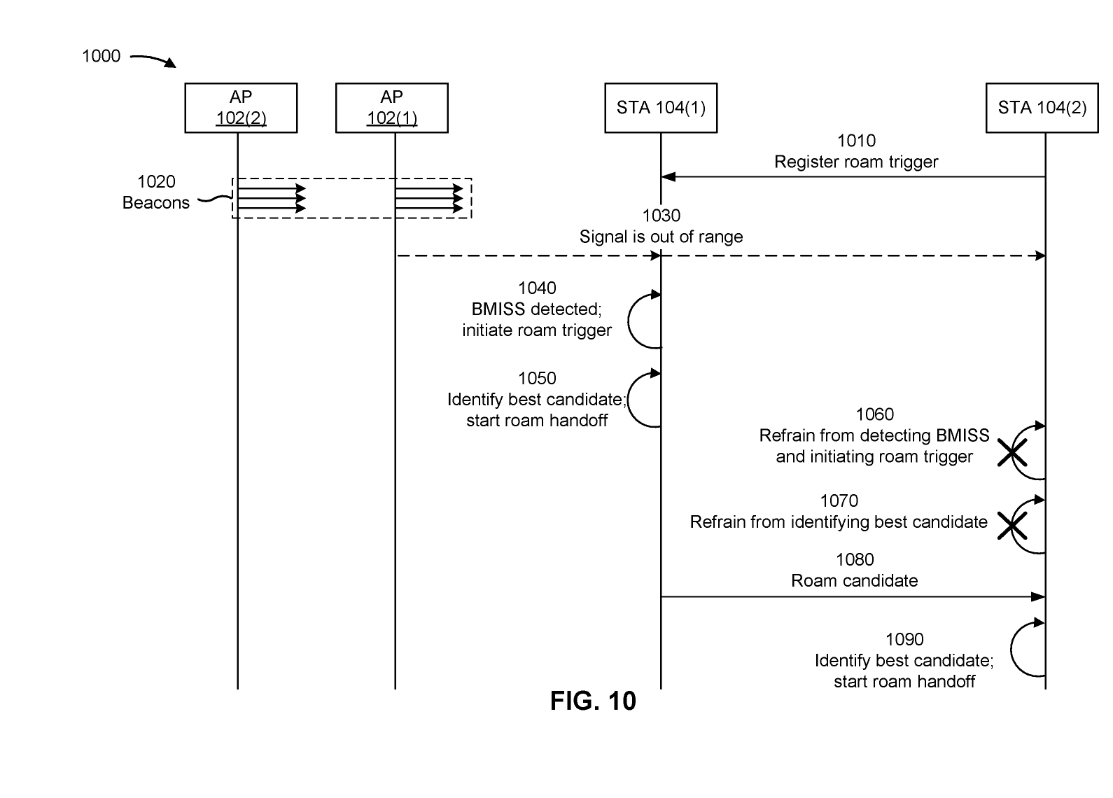

FIG. 10 is a diagram illustrating another example 1000 associated with signaling for a roam handoff based at least in part on a WPAN link, in accordance with the present disclosure.

As shown by reference number 1010, the STA 104(2) may transmit (e.g., register), and the STA 104(1) may receive, over the WPAN link, an indication of one or more roam triggers. As shown by reference number 1020, APs 102(1) and 102(2) may transmit beacons at regular intervals. As shown by reference number 1030, the STAs 104(1) and 104(2) may determine, based at least in part on the beacons transmitted by the AP 102(2), that the AP 102(1) is out of signal range.

As shown by reference number 1040, the STA 104(1) may detect a beacon miss (“BMISS”) and initiate a roam trigger, as discussed above in connection with FIG. 6. As shown by reference number 1050, the STA 104(1) may identify the AP 102(2) as the best candidate and start roam handoff, as discussed above in connection with FIG. 6. For example, the STA 104(1) may perform the first, second, and third phases of WLAN client roam triggering, as discussed above in connection with FIG. 5.

As shown by reference number 1060, the STA 104(2) may refrain from detecting a beacon miss and initiating a roam trigger. As shown by reference number 1070, the STA 104(2) may refrain from identifying the AP 102(2) as the best candidate. For example, the STA 104(2) may refrain from performing the first and second phases of WLAN client roam triggering, as discussed above in connection with FIG. 8.

As shown by reference number 1080, the STA 104(1) may transmit (e.g., forward), and the STA 104(2) may receive, over the WPAN link 108, an indication of a roam handoff candidate (e.g., the best candidate). As shown by reference number 1090, the STA 104(2) may start a roam handoff (e.g., by initiating a roam trigger to the AP 102(2)). For example, the STA 104(2) may perform the third phase of WLAN client roam triggering, as discussed above in connection with FIGS. 5 and 8.

As indicated above, FIG. 10 is provided as an example. Other examples may differ from what is described with respect to FIG. 10.

Transmitting or receiving, over the WPAN link, the indication of the roam handoff candidate may help to conserve power on the STA 104(2) by offloading at least a portion of WLAN client roam triggering to the STA 104(1). For example, the STA 104(1) may perform the first and second phases of the WLAN client roam triggering on behalf of the STA 104(2); thus, the STA 104(2) may avoid using power for identifying the roam handoff candidate (e.g., the STA 104(2) may avoid performing unnecessary scans for the roam handoff candidate, initiating a roam trigger mechanism, roam handoff tracking, or the like). Additionally, or alternatively, the STA 104(2) may refrain from transmitting probes in WLAN channels during roam scanning, thereby reducing network congestion. Thus, in some examples, the high-end infrastructure of the STA 104(1) may be exploited to identify the roam handoff candidate, thereby providing roam handover benefits for the STA 104(2).

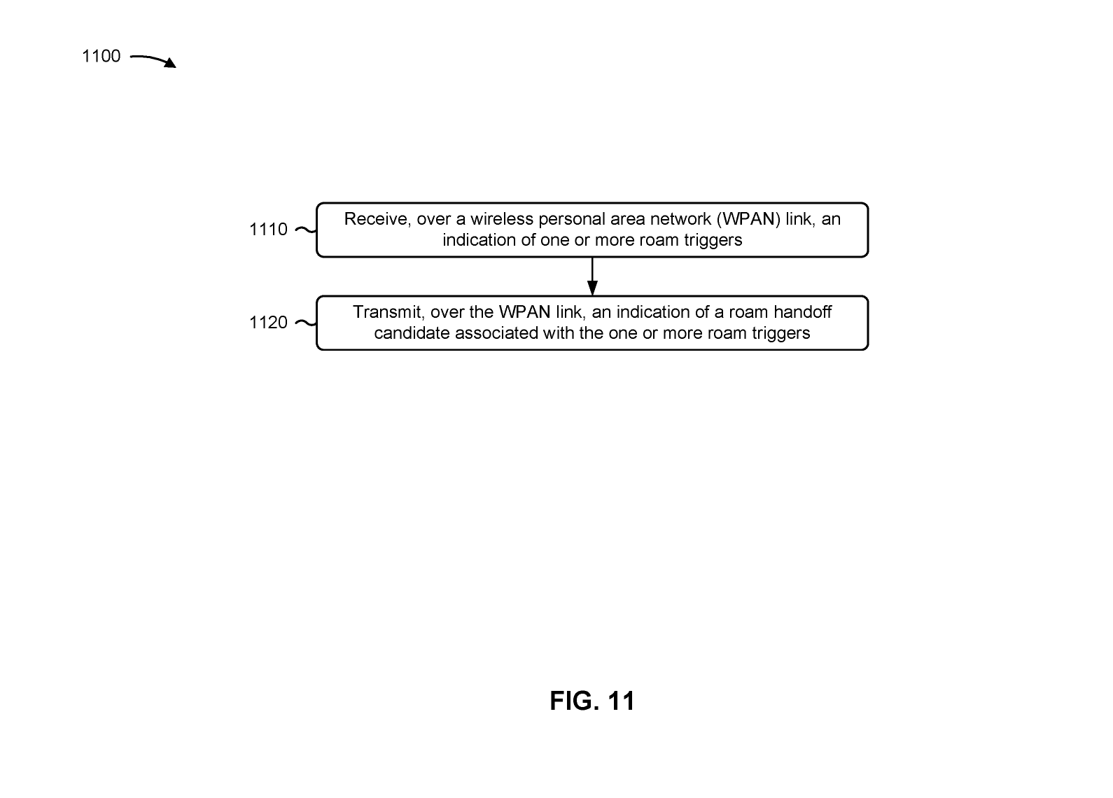

FIG. 11 is a flowchart of an example process 1100 associated with roam handoff based on a WPAN link, in accordance with the present disclosure. In some aspects, one or more process blocks of FIG. 11 are performed by a wireless station (e.g., STA 104(1)). In some aspects, one or more process blocks of FIG. 11 are performed by another device or a group of devices separate from or including the wireless station, such as an AP (e.g., AP 102) and/or a network (e.g., wireless communication network 110). Additionally, or alternatively, one or more process blocks of FIG. 11 may be performed by one or more components of device 200, such as processor 210, memory 215, input component 220, output component 225, and/or communication component 230.

As shown in FIG. 11, process 1100 may include receiving, over a WPAN link, an indication of one or more roam triggers (block 1110). For example, the wireless station may receive, over a WPAN link, an indication of one or more roam triggers, as described above.

As further shown in FIG. 11, process 1100 may include transmitting, over the WPAN link, an indication of a roam handoff candidate associated with the one or more roam triggers (block 1120). For example, the wireless station may transmit, over the WPAN link, an indication of a roam handoff candidate associated with the one or more roam triggers, as described above.

Process 1100 may include additional aspects, such as any single aspect or any combination of aspects described below and/or in connection with one or more other processes described elsewhere herein.

In a first aspect, process 1100 includes identifying an occurrence of the one or more roam triggers, and identifying, responsive to the occurrence of the one or more roam triggers, the roam handoff candidate.

In a second aspect, alone or in combination with the first aspect, the indication of the roam handoff candidate comprises an indication to perform a roam handoff associated with the roam handoff candidate.

In a third aspect, alone or in combination with one or more of the first and second aspects, the one or more roam triggers include a beacon miss roam trigger.

In a fourth aspect, alone or in combination with one or more of the first through third aspects, receiving the indication of the one or more roam triggers includes receiving the indication of the one or more roam triggers responsive to establishing the WPAN link.

In a fifth aspect, alone or in combination with one or more of the first through fourth aspects, the wireless station is a companion device associated with an IoT device.

In a sixth aspect, alone or in combination with one or more of the first through fifth aspects, the wireless station is connected to a first wireless AP associated with an ESS, and the roam handoff candidate is a second wireless AP associated with the ESS.

Although FIG. 11 shows example blocks of process 1100, in some aspects, process 1100 includes additional blocks, fewer blocks, different blocks, or differently arranged blocks than those depicted in FIG. 11. Additionally, or alternatively, two or more of the blocks of process 1100 may be performed in parallel.

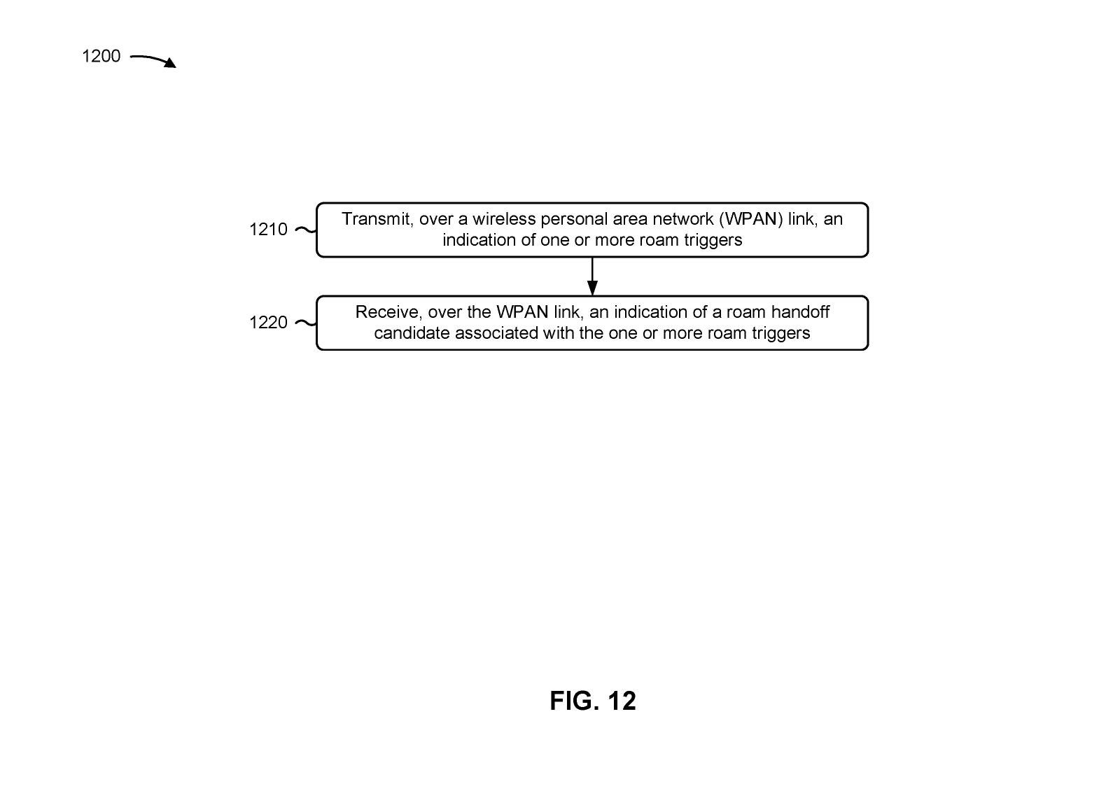

FIG. 12 is a flowchart of an example process 1200 associated with roam handoff based on a WPAN link, in accordance with the present disclosure. In some aspects, one or more process blocks of FIG. 12 are performed by a wireless station (e.g., STA 104(2)). In some aspects, one or more process blocks of FIG. 12 are performed by another device or a group of devices separate from or including the wireless station, such as an AP (e.g., AP 102) and/or a network (e.g., wireless communication network 110). Additionally, or alternatively, one or more process blocks of FIG. 12 may be performed by one or more components of device 200, such as processor 210, memory 215, input component 220, output component 225, and/or communication component 230.

As shown in FIG. 12, process 1200 may include transmitting, over a WPAN link, an indication of one or more roam triggers (block 1210). For example, the wireless station may transmit, over a WPAN link, an indication of one or more roam triggers, as described above.

As further shown in FIG. 12, process 1200 may include receiving, over the WPAN link, an indication of a roam handoff candidate associated with the one or more roam triggers (block 1220). For example, the wireless station may receive, over the WPAN link, an indication of a roam handoff candidate associated with the one or more roam triggers, as described above.

Process 1200 may include additional aspects, such as any single aspect or any combination of aspects described below and/or in connection with one or more other processes described elsewhere herein.

In a first aspect, the indication of the one or more roam triggers comprises an indication to identify an occurrence of the one or more roam triggers and identify, responsive to the occurrence of the one or more roam triggers, the roam handoff candidate.

In a second aspect, alone or in combination with the first aspect, process 1200 includes performing, responsive to receiving the indication of the roam handoff candidate, a roam handoff associated with the roam handoff candidate.

In a third aspect, alone or in combination with one or more of the first and second aspects, the one or more roam triggers include a beacon miss roam trigger.

In a fourth aspect, alone or in combination with one or more of the first through third aspects, transmitting the indication of the one or more roam triggers includes transmitting the indication of the one or more roam triggers responsive to establishing the WPAN link.

In a fifth aspect, alone or in combination with one or more of the first through fourth aspects, the wireless station is an IoT device associated with a companion device.

In a sixth aspect, alone or in combination with one or more of the first through fifth aspects, the wireless station is connected to a first wireless AP associated with an ESS, and the roam handoff candidate is a second wireless AP associated with the ESS.

Although FIG. 12 shows example blocks of process 1200, in some aspects, process 1200 includes additional blocks, fewer blocks, different blocks, or differently arranged blocks than those depicted in FIG. 12. Additionally, or alternatively, two or more of the blocks of process 1200 may be performed in parallel.

### The following provides an overview of some Aspects of the present disclosure:

Aspect 1: A method for wireless communication by a wireless station, comprising: receiving, over a wireless personal area network (WPAN) link, an indication of one or more roam triggers; and transmitting, over the WPAN link, an indication of a roam handoff candidate associated with the one or more roam triggers.

Aspect 2: The method of Aspect 1, further comprising: identifying an occurrence of the one or more roam triggers; and identifying, responsive to the occurrence of the one or more roam triggers, the roam handoff candidate.

Aspect 3: The method of any of Aspects 1-2, wherein the indication of the roam handoff candidate comprises an indication to perform a roam handoff associated with the roam handoff candidate.

Aspect 4: The method of any of Aspects 1-3, wherein the one or more roam triggers include a beacon miss roam trigger.

Aspect 5: The method of any of Aspects 1-4, wherein receiving the indication of the one or more roam triggers includes receiving the indication of the one or more roam triggers responsive to establishing the WPAN link.

Aspect 6: The method of any of Aspects 1-5, wherein the wireless station is a companion device associated with an internet of things (IoT) device.

Aspect 7: The method of any of Aspects 1-6, wherein the wireless station is connected to a first wireless access point (AP) associated with an extended service set (ESS), and wherein the roam handoff candidate is a second wireless AP associated with the ESS.

Aspect 8: A method of wireless communication by a wireless station, comprising: transmitting, over a wireless personal area network (WPAN) link, an indication of one or more roam triggers; and receiving, over the WPAN link, an indication of a roam handoff candidate associated with the one or more roam triggers.

Aspect 9: The method of Aspect 8, wherein the indication of the one or more roam triggers comprises an indication to identify an occurrence of the one or more roam triggers and identify, responsive to the occurrence of the one or more roam triggers, the roam handoff candidate.

Aspect 10: The method of any of Aspects 8-9, further comprising: performing, responsive to receiving the indication of the roam handoff candidate, a roam handoff associated with the roam handoff candidate.

Aspect 11: The method of any of Aspects 8-10, wherein the one or more roam triggers include a beacon miss roam trigger.

Aspect 12: The method of any of Aspects 8-11, wherein transmitting the indication of the one or more roam triggers includes transmitting the indication of the one or more roam triggers responsive to establishing the WPAN link.

Aspect 13: The method of any of Aspects 8-12, wherein the wireless station is an internet of things (IoT) device associated with a companion device.

Aspect 14: The method of any of Aspects 8-13, wherein the wireless station is connected to a first wireless access point (AP) associated with an extended service set (ESS), and wherein the roam handoff candidate is a second wireless AP associated with the ESS.

Aspect 15: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 16: An apparatus for wireless communication at a device, the apparatus comprising one or more memories and one or more processors coupled to the one or more memories, the one or more processors configured to cause the device to perform the method of one or more of Aspects 1-14.

Aspect 17: An apparatus for wireless communication, the apparatus comprising at least one means for performing the method of one or more of Aspects 1-14.

Aspect 18: A non-transitory computer-readable medium storing code for wireless communication, the code comprising instructions executable by one or more processors to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

Aspect 20: A device for wireless communication, the device comprising a processing system that includes one or more processors and one or more memories coupled with the one or more processors, the processing system configured to cause the device to perform the method of one or more of Aspects 1-14.

Aspect 21: An apparatus for wireless communication at a device, the apparatus comprising one or more memories and one or more processors coupled to the one or more memories, the one or more processors individually or collectively configured to cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless station, comprising:
a processing system that includes processor circuitry and memory circuitry that stores code, the processing system configured to cause the wireless station to:
receive, over a wireless personal area network (WPAN) link, an indication of one or more roam triggers; and
transmit, over the WPAN link, an indication of a roam handoff candidate associated with the one or more roam triggers.

2. The wireless station of claim 1, wherein the processing system is further configured to cause the wireless station to:
identify an occurrence of the one or more roam triggers; and
identify, responsive to the occurrence of the one or more roam triggers, the roam handoff candidate.

3. The wireless station of claim 1, wherein the indication of the roam handoff candidate comprises an indication to perform a roam handoff associated with the roam handoff candidate.

4. The wireless station of claim 1, wherein the one or more roam triggers include a beacon miss roam trigger.

5. The wireless station of claim 1, wherein the processing system, to cause the wireless station to receive the indication of the one or more roam triggers, is configured to cause the wireless station to receive the indication of the one or more roam triggers responsive to establishing the WPAN link.

6. The wireless station of claim 1, wherein the wireless station is a companion device associated with an internet of things (IoT) device.

7. The wireless station of claim 1, wherein the wireless station is connected to a first wireless access point (AP) associated with an extended service set (ESS), and wherein the roam handoff candidate is a second wireless AP associated with the ESS.

8. A method for wireless communication by a wireless station, comprising:
receiving, over a wireless personal area network (WPAN) link, an indication of one or more roam triggers; and
transmitting, over the WPAN link, an indication of a roam handoff candidate associated with the one or more roam triggers.

9. The method of claim 8, further comprising:
identifying an occurrence of the one or more roam triggers; and
identifying, responsive to the occurrence of the one or more roam triggers, the roam handoff candidate.

10. The method of claim 8, wherein the indication of the roam handoff candidate comprises an indication to perform a roam handoff associated with the roam handoff candidate.

11. The method of claim 8, wherein the one or more roam triggers include a beacon miss roam trigger.

12. The method of claim 8, wherein receiving the indication of the one or more roam triggers includes receiving the indication of the one or more roam triggers responsive to establishing the WPAN link.

13. The method of claim 8, wherein the wireless station is a companion device associated with an internet of things (IoT) device.

14. The method of claim 8, wherein the wireless station is connected to a first wireless access point (AP) associated with an extended service set (ESS), and wherein the roam handoff candidate is a second wireless AP associated with the ESS.

15. An apparatus for wireless communication, comprising:
means for receiving, over a wireless personal area network (WPAN) link, an indication of one or more roam triggers; and
means for transmitting, over the WPAN link, an indication of a roam handoff candidate associated with the one or more roam triggers.

16. The apparatus of claim 15, further comprising:
means for identifying an occurrence of the one or more roam triggers; and
means for identifying, responsive to the occurrence of the one or more roam triggers, the roam handoff candidate.

17. The apparatus of claim 15, wherein the indication of the roam handoff candidate comprises an indication to perform a roam handoff associated with the roam handoff candidate.

18. The apparatus of claim 15, wherein the one or more roam triggers include a beacon miss roam trigger.

19. The apparatus of claim 15, wherein the means for receiving the indication of the one or more roam triggers includes means for receiving the indication of the one or more roam triggers responsive to establishing the WPAN link.

20. The apparatus of claim 15, wherein the apparatus is a companion device associated with an internet of things (IoT) device.
